(19) United States
(12) Patent Application Publication
(10) Pub. No.: US 2009/0202685 A1
(43) Pub. Date: Aug. 13, 2009

(54) Food Package

(76) Inventor: Roberto Foeaman, Lawrenceville, NJ (US)

Correspondence Address: JAY M. SCHLOFF;INTELLIPEX PLLC, 30200 TELEGRAPH RD, SUITE 245, BINGHAM FARMS, MI, 48025, US

(21) Appl. No.: 12/029,757

(22) Filed: Feb. 12, 2008

(51) Int. Cl. A23L 1/315; B65B 25/06; A23L 1/317

(52) U.S. Cl. 426/129; 426/644

(57) ABSTRACT

Disclosed is a food package that includes a nutritional and an easy-to-preserve chicken food product, and, a can for storing the food product. The chicken food product includes a quantity of chicken liver, a quantity of chicken gizzard, a quantity of garlic, a piece of ginger, a quantity of cooking oil, a quantity of sweet soy sauce, and a volume of water. The chicken food product may be regularly utilized by people with a low blood count. Further, disclosed is a method for preparing the chicken food product that is preserved in the food package.

### FIELD OF THE INVENTION

The present invention generally relates to a food package, and, more specifically, to a food package that includes a chicken food product possessing nutritional qualities.

### BACKGROUND OF THE INVENTION

Various food products are available in attractive, and marketable, food packages. These food products include various raw ingredients, such as those obtained from animals like pork and beef. However, the raw ingredients obtained from pork and beef are known to contain high fat and cholesterol content.

Presently, raw ingredients obtained from chicken are a preferred source of raw ingredients for preparing the food products since such raw ingredients includes low cholesterol content. More specifically, the food products obtained from chicken have high nutritional content, and accordingly may be consumed by people suffering from various blood related diseases, such as low blood count. However, the food products prepared from chicken tend to become rancid very quickly, thereby, spoiling the food products.

Accordingly, there is a need for a chicken food product for consumption by a person having a low blood count. More specifically, the chicken food product should possess high nutritional value. Further, there is a need for a food package for enabling an easy preservation of the chicken food product. Furthermore, there is a need for a method to prepare the nutritional and easy-to-preserve a chicken food product.

### SUMMARY OF THE INVENTION

In view of the foregoing disadvantages inherent in the prior art, the general purpose of the present invention is to provide a food package that includes a chicken food product possessing nutritional qualities and a can for storing the chicken food product, which includes all the advantages of the prior art, and overcomes the drawbacks inherent therein.

Accordingly, an object of the present invention is to provide a food package that includes an easy-to-preserve chicken food product, and, a can for storing the chicken food product.

Another object of the present invention is to provide a food package that includes a chicken food product that possesses nutritional qualities, which may be regularly consumed by people with a low blood count.

Yet another object of the present invention is to provide a method for preparing a chicken food product that possesses nutritional qualities and that may be easily packaged and preserved.

In light of the above objects, in one aspect the present invention provides a method for preparing a chicken food product. The method includes boiling a quantity of chicken liver until the chicken liver becomes firm, and boiling a quantity of chicken gizzard until the chicken gizzard becomes firm. The method further includes grinding the boiled chicken liver and the boiled chicken gizzard. Further, the method includes mixing the ground chicken liver and the ground chicken gizzard to obtain a mixture thereof. Thereafter, the method includes grinding a quantity of garlic and a quantity of ginger. Moreover, the method includes adding the mixture of the ground chicken liver and the ground chicken gizzard, the ground garlic, and the ground ginger to a pre-heated cooking oil to obtain a concoction. Thereafter, the concoction may be steam-heated for a first predetermined time duration. Subsequently, a quantity of sweet soy sauce and a quantity of water may be added to the steam-heated concoction to obtain a final concoction. The final concoction may be steam-heated for a second predetermined time duration to obtain the chicken food product.

In another aspect, the present invention provides a method for preparing the chicken food product that possesses nutritional qualities and that may be easily packaged and preserved.

In yet another aspect, the present invention provides a food package that includes a chicken food product and a can for storing the chicken food product. The chicken food product includes a quantity of chicken liver, a quantity of chicken gizzard, a quantity of garlic, a quantity of ginger, a quantity of cooking oil, a quantity of Kecap Manis Sedang sauce, and a quantity of water.

These together with other aspects of the present invention, along with the various features of novelty that characterize the present invention, are pointed out with particularity in the claims annexed hereto and form a part of the present invention. For a better understanding of the present invention, its operating advantages, and the specific objects attained by its uses, reference should be made to the accompanying drawing and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 is a perspective view of a food package, according to an embodiment of the present invention; and

FIG. 2 is a flow diagram illustrating a method for preparing a chicken food product, according to an embodiment of the present invention.

Like reference numerals refer to like parts throughout the description of several views of the drawings.

### DETAILED DESCRIPTION OF THE INVENTION

The exemplary embodiments described herein detail for illustrative purposes and are subject to many variations in structure and design. It should be emphasized, however, that the present invention is not limited to a particular food package, as shown and described. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting. The terms “a” and “an” herein do not denote a limitation of quantity, but rather denote the presence of at least one of the referenced item.

As used herein, the term “concoction” refers to either a mixture or a foodstuff prepared by combining different ingredients, and, is either used or prepared for consumption as food.

As used herein, a term “hot spicy version” refers to a specific variety of a chicken food product that includes a high quantity of spices. Such spices used for flavoring the chicken food product include, but are not limited to, peppers, turmeric, garlic, ginger, and the like. Usually, the hot spicy version of the chicken food product may produce a burning sensation on a consumer's taste nerves.

As used herein, a term “mild spicy version” refers to a specific variety of a chicken food product that includes a moderate quantity of spices for flavoring the chicken food product. Usually, the mild spicy version of the chicken food product may not produce a burning sensation on a consumer's taste nerves.

As used herein, a term “non spicy version” refers to a specific variety of a chicken food product that includes either a low or an insignificant quantity of spices.

As used herein, the term “steam-heating” refers to a method for heating a chicken food product by means of heated water vapors. More specifically, the method includes generation of pressurized steam and passing the steam over the chicken food product in order to cook the chicken food product.

The present invention provides a food package that includes a nutritional and an easy-to-preserve chicken food product, and, a can for storing the chicken food product. The chicken food product preserved in the food package, as described herein, is as a delicious paste. The chicken food product includes chicken liver and chicken gizzard as the primary ingredients. The chicken food product further includes garlic, ginger, cooking oil, a sweet soy sauce, and water. In addition, the present invention provides a method for preparing the chicken food product that has nutritional value and that may be easily packaged and preserved. Further, the chicken food product may be used as a hot condiment in any cuisine or meal. Additionally, the chicken food product may be regularly utilized by people with a low blood count due to the nutritional qualities thereof.

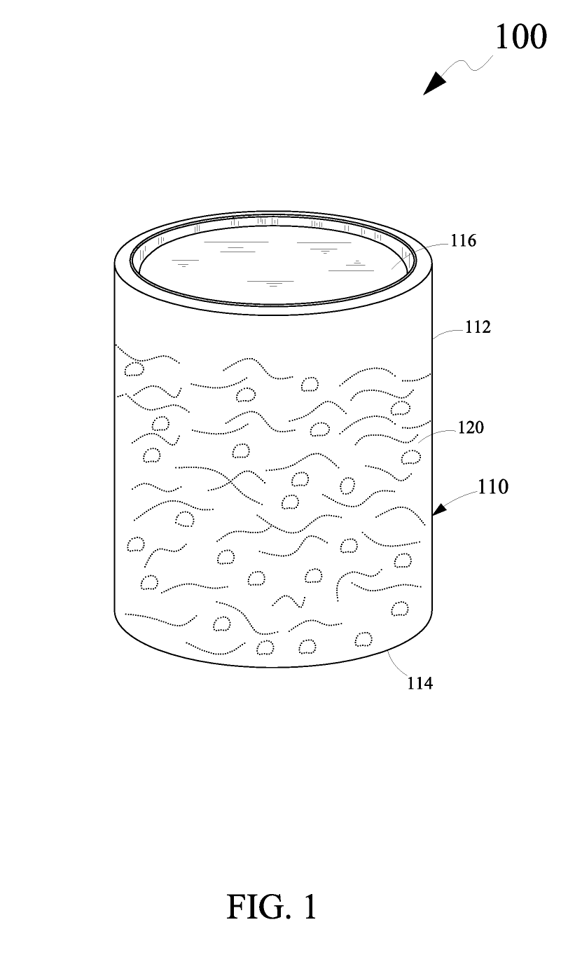

FIG. 1 is a perspective view of a food package 100, according to an embodiment of the present invention. The food package 100 includes a can 110 and a chicken food product 120 (herein after referred to as food product 120), stored in the can 110. More specifically, the can 110 includes a body 112 (hereinafter referred to as can body 112) having an open top end (not shown) and a closed bottom end 114. The can 110 further includes a lid 116 for covering the open top end of the can body 112. The lid 116 may be lifted from the open top end of the can body 112 for facilitating storage of the food product 120 within the can body 112, and withdrawal of the food product 120 therefrom. In an embodiment of the present invention, the lid 116 may be tightly disposed on the open top end of the can body 112 by means of an airtight seal (not shown). The airtight seal helps in retaining the food product 120 inside the can 110. Further, the airtight seal may be made of a metal or any other material that provides sufficient structural integrity to the airtight seal.

In another embodiment of the present invention, the lid 116 may be configured to be fusible with the can body 112. More specifically, after storing the food product 120 inside the can body 112, the lid 116 may be fused with the can body 112 using a can seamer, a pressure canner, a water bath canner, and such similar equipments. For opening the lid 116 of the can 110, a user may require to either cut or tear off the lid 116. It will be apparent to a person skilled in the art that the can body 112 and the lid 116, as described in the said embodiment, may be composed of the same material.

The can 110 may also include a label (not shown) in form of either a printed paper or a plastic label. The label may be attached to an outer surface of the can body 112, for indicating contents and ingredients of the food product 120 stored within the can 110. Without departing from the scope of the present invention, the label may be painted directly onto the material used for making the can 110. It will be evident to a person skilled in the art that the label may be designed in standard or custom sizes and shapes, colors, and materials, depending on a manufacturer's preferences, and accordingly may not be considered as limiting to the scope of the present invention.

In FIG. 1, the can 110 is shown to have a cylindrical shape. However, the present invention is not intended to be limited thereto. Accordingly, the can 110 may be of any other shape such as a conical shape, a cuboidal shape, and the like. Alternatively, the can 110 may take on any design that is aesthetically pleasing to the user. Moreover, the can 110 may be made of a structurally strong, thin, lightweight, attractive, and stackable material. Examples of such materials include tin, tin-plated steel, aluminum, and the like. Further, it will be apparent to a person skilled in the art that the can 110 may have any size, shape, and configuration, which is sufficient to store a desired quantity of the food product 120 therein.

The food product 120 stored in the can 110 includes a quantity of chicken liver and a quantity of chicken gizzard as primary ingredients. The use of chicken liver and chicken gizzard in food product 120 enhances a nutritional value thereof. More specifically, the food product 120 includes a high mineral content, and, low cholesterol and fat content. Accordingly, the food product 120 may be utilized by people having a low blood count.

The food product 120 further includes a quantity of garlic, a quantity of ginger, a quantity of cooking oil, and a quantity of a sweet soy sauce as the essential ingredients. Moreover, the food product 120 includes a quantity of water as additional ingredient required for various cooking processes, such as boiling, steam-heating, and the like. Without limiting the scope of the present invention, the sweet soy sauce may include Kecap Manis Sedang sauce.

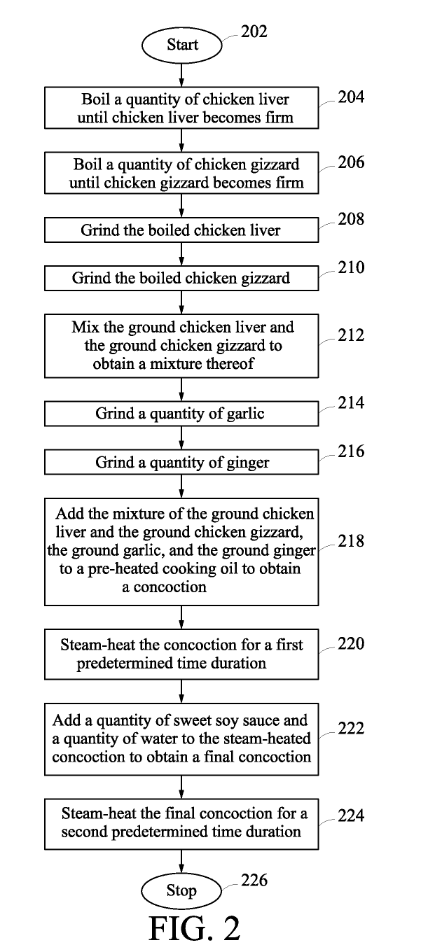

In a preferred embodiment of the present invention, the food product 120 may include about two pounds of chicken liver, about two pounds of chicken gizzard, about one fourth of a pound of garlic, one ounce of ginger, about eight ounces of cooking oil, about 12 ounces of Kecap Manis Sedang sauce, and about 30 ounces of water. In addition to the foregoing ingredients, the food product 120 may additionally include Caribbean hot pepper, seasoned salt, and other spices as seasoning for enhancing taste of the food product. More specifically, the quantities of said spices may be varied in the food product for obtaining different versions thereof, for example, the hot spicy version, the mild spicy version, and the non spicy version of the food product 120. A method for preparation of the food product 120 will be explained in detail in conjunction with FIG. 2.

FIG. 2 is a flow diagram illustrating a method for preparing the food product 120, according to an embodiment of the present invention. For the purpose of this description, the method and the techniques used to prepare the food product 120 involve the use of containers to hold and cook various ingredients of the food product 120, preparation equipments for chopping and cutting the ingredients, stirring tools, and a heat source. Examples of the heat source include, but are not limited to, a gas stove, an electric range, a microwave, and the like.

The method for preparing the food product 120 starts at step 202. At step 202, a container for holding and cooking the various ingredients of the food product 120 is kept ready on a heat source. The container is an open top container, which may be covered by a lid whenever required. Suitable examples of the container include a pan with a lid, a saucepan, and the like. At step 204, a quantity of chicken liver is boiled in the container that is kept on the heat source, until the chicken liver becomes firm. Preferably, about two pounds of chicken liver is boiled in the container for at least 30 minutes. Further, at step 206, a quantity of chicken gizzard is boiled in a container until the chicken liver becomes firm. More specifically, about two pounds of chicken gizzard is boiled at least for 30 minutes in the container. The container for boiling the chicken gizzard may be similar to the container used for boiling the chicken liver. Alternatively, the container used for boiling the chicken liver may be washed and subsequently used for boiling the chicken gizzard.

Without departing from the scope of the present invention, it should be apparent to a person skilled in the art that the chicken liver and the chicken gizzard may be boiled together in the container at least for 30 minutes or until both become firm. In another embodiment of the present invention, the chicken gizzard may be boiled before boiling the chicken liver.

At step 208, the boiled chicken liver is subjected to grinding. The grinding may be carried out using either a mortar and pestle, or a manual or an electric grinding machine. Thereafter, the boiled chicken gizzard may be subjected to grinding, at step 210. More specifically, the boiled chicken gizzard may be cut into small pieces, which are subjected to grinding. The grinding may be carried out using the similar techniques as used for grinding the boiled chicken liver. Alternatively, the boiled chicken liver and the boiled chicken gizzard may be subjected to grinding simultaneously.

The ground chicken liver prepared at step 208 and the ground chicken gizzard prepared at step 210 may be mixed at step 212 to obtain a fine paste-like mixture. The said mixing may be carried out in either a fresh container or one of the containers used for boiling the chicken liver and the chicken gizzard. The mixing may be carried out by means of a stirring tool. Suitable examples of the stirring tool include, but are not limited to, a wooden spoon, a wooden spatula, a plastic spoon, and a plastic spatula.

Thereafter, a quantity of garlic is chopped and grinded at step 214 to obtain ground garlic. More specifically, about one fourth of a pound the garlic may be chopped in small pieces using either a knife or an electric chopping machine. The small pieces may be subjected to grinding using either a mortar and pestle, or an electric grinding machine. Subsequently, a quantity of ginger is subjected to grinding at step 216 to obtain ground ginger. Preferably, about one ounce of ginger may be ground using a similar technique as used for grinding the garlic. Alternatively, the ginger may be chopped in small pieces and the small pieces may then be subjected to grinding.

At step 218, the fine paste-like mixture of the ground chicken liver and the ground chicken gizzard obtained at step 212, the ground garlic obtained at 214, and the ground ginger obtained at step 216 are added to a container holding a quantity of a pre-heated cooking oil. More specifically, about eight ounces of cooking oil may be pre-heated in a clean container that is open at top, and utilized herein. The cooking oil may be an edible vegetable oil. Suitable examples of the edible vegetable oil include, but are not limited to, olive oil, palm oil, soybean oil, canola oil, pumpkin seed oil, corn oil, sunflower oil, safflower oil, peanut oil, grape seed oil, sesame oil, argan oil, and rice bran oil. Further, the contents of the container are mixed well in the pre-heated cooking oil with the help of the stirring tool. The contents are mixed and cooked together to obtain a concoction. In addition to the above-mentioned contents, additional flavoring agents like Caribbean hot pepper, seasoned salt, and other spices may be added to the concoction in the container at step 218 for seasoning the concoction. The quantities of the flavoring agents, as described herein, may be varied in the food product 120 for preparing the hot spicy version, the mild spicy version and the non spicy version of the food product 120.

Once the concoction is prepared, the container holding the concoction is closed by placing a lid thereon. The concoction in the container is subjected to steam-heating for a first predetermined duration of time at step 220. In one embodiment of the present invention, the first predetermined time duration is a time during which the concoction dries off completely without being stuck to the container. When the concoction dries off completely, the lid of the container is removed, and a quantity of sweet soy sauce along with a quantity of water is added to the container, at step 222. More specifically, about 12 ounces of Kecap Manis Sedang sauce and about 30 ounces of water is added to the steam-heated concoction. The sweet soy sauce along with the water are mixed well with the steam-heated concoction using the stirring tool in order to obtain a final concoction. Thereafter, the lid of the container holding the final concoction is closed thereon. The final concoction is subjected to steam-heating for a second pre-determined time duration at step 224. In one embodiment, the second predetermined time duration is a time during which the water added to the final concoction vaporizes completely resulting in the formation of the food product 120. Thereafter, the method stops at step 226.

The temperature of the food product 120 may be reduced by storing the food product 120 at room temperature. Alternatively, the preparation may be served directly. In an embodiment of the present invention, the food product 120 may be stored in a can, for example, the can 110. The food product 120 and the can 110 for storing the food product 120 collectively form a food package, such as the food package 100, explained in detail in conjunction with FIG. 1.

The food package disclosed herein may be stored in a ready-to-use form and refrigerated for future utilization. In use, the refrigerated food product may be warmed to a small extent using either a stove or a microwave before consumption. In another embodiment, the can 110 storing the food product 120 may directly be warmed before the withdrawal of the food product 120 from within the can 110.

It will be apparent to a person skilled in the art that there are various other food products that may be prepared from similar combinations and configurations of the present invention. Accordingly, the description provided herein is exemplary and not limiting in its nature.

Further, it may be evident that the manner and methods used for any commercial preparation of the chicken food product of the present invention may use other processes. For instance, industrial mixing chambers may be utilized to combine, heat, and prepare the nutritional food product. Similarly, the specific time and temperature required for preparing the chicken food product and its ingredients may vary depending on the type of the commercial process. However, it should be appreciated by one skilled in the art that the ingredients described in the detailed description and the accompanying flowchart do not limit commercial variations to the process and manner to produce the chicken food product of the present invention. Nevertheless, the primary and the essential ingredients should remain the same as described herein.

The present invention provides a chicken food product, herein after referred to as the food product, having a high nutritional content. The disclosed food product may be utilized by people with a low blood count. Further, the food product may be preserved in a can in the form of a food package. The food product preserved in the food package may be available in different varieties that include a hot spicy version, a mild spicy version, and a non-spicy version. The hot spicy version may be consumed as a hot condiment along with meals. Alternatively, the hot spicy version may also be used in a sandwich as a filling thereof. Further, the food product may be consumed with rice, fresh salads, and a platter along with plantains and potatoes. Furthermore, the food product may be used as a lunch meat and as a filling to prepare pastels. In addition, the food product may be prepared in the form of a sausage. Further, the method for preparing the food product, as described herein, serves as an effective way to provide a nutritional food product, which may be preserved in form of a food package.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, to thereby enable others skilled in the art to best utilize the present invention and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present invention.

What is claimed is:

1. A method for preparing a chicken food product, the method comprising:
boiling a quantity of chicken liver until the chicken liver becomes firm;
boiling a quantity of chicken gizzard until the chicken gizzard becomes firm;
grinding the boiled chicken liver;
grinding the boiled chicken gizzard;
mixing the ground chicken liver and the ground chicken gizzard to obtain a mixture thereof;
grinding a quantity of garlic;
grinding a quantity of ginger;
adding the mixture of the ground chicken liver and the ground chicken gizzard, the ground garlic, and the ground ginger to a pre-heated cooking oil to obtain a concoction;
steam-heating the concoction for a first predetermined time duration;
adding a quantity of sweet soy sauce and a quantity of water to the steam-heated concoction to obtain a final concoction; and
steam-heating the final concoction for a second predetermined time duration to obtain the food product.

2. The method of claim 1, wherein the first predetermined time duration is a time during which the concoction dries off completely.

3. The method of claim 1, wherein the second predetermined time duration is a time during which the added water in the final concoction vaporizes completely.

4. The method of claim 1, wherein the quantity of chicken liver is about two pounds.

5. The method of claim 1, wherein the quantity of chicken gizzard is about two pounds.

6. The method of claim 1, wherein the quantity of garlic is about one fourth of a pound.

7. The method of claim 1, wherein the quantity of cooking oil is about eight ounces.

8. The method of claim 1, wherein the quantity of sweet soy sauce is about 12 ounces.

9. The method of claim 1, wherein the quantity of ginger is about one ounce.

10. The method of claim 1, wherein the quantity of water is about 30 ounces.

11. The method of claim 1, further comprising adding at least one of Caribbean hot pepper, seasoned salt, and spices for seasoning the steam-heated concoction.

12. A food package comprising:
a chicken food product prepared by admixing
a quantity of chicken liver,
a quantity of chicken gizzard,
a quantity of garlic,
a quantity of ginger,
a quantity of cooking oil,
a quantity of sweet soy sauce, and
a quantity of water; and
a can for storing the chicken food product.

13. The food package of claim 12, wherein the quantity of chicken liver is about two pounds.

14. The food package of claim 12, wherein the quantity of chicken gizzard is about two pounds.

15. The food package of claim 12, wherein the quantity of garlic is about one fourth of a pound.

16. The food package of claim 12, wherein the quantity of cooking oil is about eight ounces.

17. The food package of claim 12, wherein the quantity of sweet soy sauce is about 12 ounces.

18. The food package of claim 12, wherein the quantity of ginger is about one ounce.

19. The food package of claim 12, wherein the quantity of water is about 30 ounces.

20. The food package of claim 12, wherein the chicken food product further comprises at least one of Caribbean hot pepper, seasoned salt, and spices as seasoning.

21. The food package of claim 12, wherein the chicken food product is in form of a sausage.
